(19) United States
(12) Patent Application Publication
(10) Pub. No.: US 2023/0186565 A1
(43) Pub. Date: Jun. 15, 2023

(54) APPARATUS AND METHOD FOR GENERATING LIGHTWEIGHT THREE-DIMENSIONAL MODEL BASED ON IMAGE

(71) Applicant: ELECTRONICS AND TELECOMMUNICATIONS RESEARCH INSTITUTE, Daejeon (KR)

(72) Inventors: Kyung Kyu KANG, Daejeon (KR); Chang Joon PARK, Daejeon (KR)

(73) Assignee: ELECTRONICS AND TELECOMMUNICATIONS RESEARCH INSTITUTE, Daejeon (KR)

(21) Appl. No.: 17/900,300

(22) Filed: Aug. 31, 2022

(30) Foreign Application Priority Data
Dec. 9, 2021 (KR) 10-2021-0175934

(51) Int. Cl. G06T 17/20; G06T 15/04

(52) U.S. Cl. CPC G06T 17/205; G06T 15/04

(57) ABSTRACT

Disclosed herein an apparatus and method for generating a lightweight three-dimensional model based on an image. The method comprising: generating a point cloud by analyzing an input image; generating an ultra lightweight mesh based on the point cloud and generating a lightweight mesh capable of texture mapping based on the generated ultra lightweight mesh; generating a texture from the input image; and storing the generated lightweight mesh and the texture.

### CROSS REFERENCE TO RELATED APPLICATION

The present application claims priority to a Korean patent application 10-2021-0175934, filed Dec. 9, 2021, the entire contents of which are incorporated herein for all purposes by this reference.

### BACKGROUND OF THE INVENTION

### Field of the Invention

The present disclosure relates to an apparatus and method for generating a three-dimensional model, and more particularly, to an apparatus and method for replicating a lightweight three-dimensional urban model based on an image.

### Description of the Related Art

The technology of replicating an object based on an image-based three-dimensional reconstruction method is being developed at a fast pace in various aspects, and many software products implementing popularized versions of the technology have been released. Basically, the method generates a high-quality mesh model as an output from an input of multiview photo of an object. In addition, the technology is used in a process of replicating a three-dimensional map of a city that closely resembles reality. Results thus obtained are utilized for various purposes including VR tour, special effects of films, and the backgrounds of games.

However, many fields still need lightweight urban models including simplified buildings. Such fields are air current or heat simulation, radio wave propagation simulation, virtual reality and other contents requiring a rendering speed. There are companies that fabricate and sell lightweight urban models.

However, in the conventional method of making a lightweight model, the process is manually carried out based on a high-quality replicate model, and even when a lightening technology is used, a subsequent manual work is necessary to acquire a satisfactory output, thereby causing the problem of user inconvenience.

### SUMMARY

The present disclosure is directed to provide an apparatus and method for automatically generating a three-dimensional model that is a lightweight urban model consisting of simplified buildings, when replicating a three-dimensional urban model from multiple pieces of image information of a target urban area.

Other objects and advantages of the present invention will become apparent from the description below and will be clearly understood through embodiments. In addition, it will be easily understood that the objects and advantages of the present disclosure may be realized by means of the appended claims and a combination thereof.

According to an embodiment of the present disclosure, there is provided a method for generating a lightweight three-dimensional model based on an image. The method comprising: generating a point cloud by analyzing an input image; generating an ultra lightweight mesh based on the point cloud and generating a lightweight mesh capable of texture mapping based on the generated ultra lightweight mesh; generating a texture from the input image; and storing the generated lightweight mesh and the texture.

According to the embodiment of the present disclosure, the method may be further comprising: grouping the point cloud; generating the ultra lightweight mesh based on the grouped point cloud; generating the lightweight mesh by performing a remeshing operation based on the generated ultra lightweight mesh; and generating, based on the lightweight mesh, a texture coordinate corresponding to the texture.

According to the embodiment of the present disclosure, wherein the grouping of the point cloud may comprise grouping the point cloud in any one face unit of a wall face or a roof face of the input image.

According to the embodiment of the present disclosure, wherein the grouping of the point cloud may comprise grouping the point cloud in a different color in each building included in the input image.

According to the embodiment of the present disclosure, wherein the generating of the ultra lightweight mesh based on the grouped point cloud may further comprise: placing an initial plane on the grouped point cloud; placing a final plane by tuning at least one of a slope and a position of the placed initial plane; and generating the ultra lightweight mesh by cutting based on a relation between the placed final plane and a neighboring plane.

According to the embodiment of the present disclosure, wherein the generating of the lightweight mesh by performing the remeshing operation based on the generated ultra lightweight mesh may further comprise generating the lightweight mesh by performing the remeshing operation that makes the ultra lightweight mesh uniform in a predetermined size.

According to the embodiment of the present disclosure, wherein a number of the lightweight mesh may be different from a number of the ultra lightweight mesh.

According to the embodiment of the present disclosure, wherein the generating of the texture coordinate corresponding to the texture based on the lightweight mesh may further comprise: grouping the lightweight mesh based on a position; generating a texture patch based on the grouped lightweight mesh; and generating the texture coordinate based on the generated texture patch.

According to the embodiment of the present disclosure, wherein the texture coordinate may be generated by using a UV layout automatic generation technique based on the generated texture patch.

According to the embodiment of the present disclosure, wherein the input image may include a two-dimensional image.

According to another embodiment of the present disclosure, there is provided an apparatus for generating a lightweight three-dimensional model based on an image. The apparatus comprising: an input image analyzer configured to generate a point cloud by analyzing an input image; a lightweight mesh generator configured to generate an ultra lightweight mesh based on the point cloud and to generate a lightweight mesh capable of texture mapping based on the generated ultra lightweight mesh; a texture generator configured to generate a texture from the input image; and a storage unit configured to store the generated lightweight mesh and the generated texture.

According to another embodiment of the present disclosure, wherein the lightweight mesh generator may be further configured to: group the point cloud, generate the ultra lightweight mesh based on the grouped point cloud, generate the lightweight mesh by performing a remeshing operation based on the generated ultra lightweight mesh, and generate, based on the lightweight mesh, a texture coordinate corresponding to the texture.

According to another embodiment of the present disclosure, wherein the lightweight mesh generator may be further configured to group the point cloud in any one face unit of a wall face or a roof face of the input image.

According to another embodiment of the present disclosure, wherein the lightweight mesh generator may be further configured to group the point cloud in a different color in each building included in the input image.

According to another embodiment of the present disclosure, wherein the lightweight mesh generator may be further configured to: place an initial plane on the grouped point cloud, place a final plane by tuning at least one of a slope and a position of the placed initial plane, and generate the ultra lightweight mesh by cutting based on a relation between the placed final plane and a neighboring plane.

According to another embodiment of the present disclosure, wherein the lightweight mesh generator may be further configured to: generate the lightweight mesh by performing the remeshing operation that makes the ultra lightweight mesh uniform in a predetermined size.

According to another embodiment of the present disclosure, wherein a number of the lightweight mesh may be different from a number of the ultra lightweight mesh.

According to another embodiment of the present disclosure, wherein the lightweight mesh generator may be further configured to: group the lightweight mesh based on a position, generate a texture patch based on the grouped lightweight mesh, and generate the texture coordinate based on the generated texture patch.

According to another embodiment of the present disclosure, wherein the lightweight mesh generator may be further configured to generate the texture coordinate by using a UV layout automatic generation technique based on the generated texture patch.

According to another embodiment of the present disclosure, there is provided an apparatus for generating a lightweight three-dimensional model based on an image. The apparatus comprising: a transceiver configured to transmit and receive data to and from an external apparatus; a processor configured to: generate a point cloud by analyzing an input image corresponding to the data, generate an ultra lightweight mesh based on the point cloud, generate a lightweight mesh capable of texture mapping based on the generated ultra lightweight mesh, and generate a texture from the input image; and a memory configured to store the generated lightweight mesh and the generated texture.

According to an embodiment of the present disclosure, since it is possible to automatically generate a simplified model, which represents an external feature of a building based on a multiview image, and a lightweight urban model expressed by the building, there is an advantage that a sufficient data storage space can be secured and a lightweight model can be easily transmitted outside.

According to another embodiment of the present disclosure, since it is possible to automatically generate a simplified model, which represents an external feature of a building based on a multiview image, and a lightweight urban model expressed by the building, a subsequent manual process can be skipped and thus user convenience can be enhanced.

According to another embodiment of the present disclosure, a simplified model, which represents an external feature of a building based on a multiview image, and a lightweight urban model expressed by the building may be automatically generated, and a lightweight model may be used as a distant view or background model for improving the visualization speed of various contents and also be utilized as a target model in urban engineering simulation technology, thereby enhancing user convenience.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a view illustrating a configuration of an image-based lightweight three-dimensional model replication device according to an embodiment of the present disclosure.

FIG. 2 is a flowchart showing a method for replicating a lightweight three-dimensional model based on an image according to an embodiment of the present disclosure.

FIG. 3 is a view illustrating a process of generating a lightweight mesh model capable of texture mapping according to an embodiment of the present disclosure.

FIG. 4A is a view illustrating an input image according to an embodiment of the present disclosure.

FIG. 4B is a view illustrating a point cloud according to an embodiment of the present disclosure.

FIG. 5A is a view illustrating a high-density mesh model of the related art.

FIG. 5B is a view illustrating addition of a texture to a high-density mesh model of the related art.

FIG. 6A is a view illustrating a lightweight model of the present invention according to an embodiment of the present disclosure.

FIG. 6B is a view illustrating addition of a texture to a lightweight model of the present invention according to an embodiment of the present disclosure.

FIG. 7A is a view illustrating a step of grouping a point cloud according to an embodiment of the present disclosure.

FIG. 7B is a view illustrating a step of generating an ultra lightweight mesh model according to an embodiment of the present disclosure.

FIG. 8A is a view illustrating a step of generating a lightweight mesh according to an embodiment of the present disclosure.

FIG. 8B is a view illustrating a step of generating a texture coordinate according to an embodiment of the present disclosure.

FIG. 9 is a view illustrating a process of generating a lightweight mesh according to an embodiment of the present disclosure.

FIG. 10 is a view illustrating a configuration of an image-based lightweight three-dimensional model replication device according to an embodiment of the present disclosure.

### DETAILED DESCRIPTION OF THE INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

In the present document, such phrases as ‘A or B’, ‘at least one of A and B’, ‘at least one of A or B’, ‘A, B or C’, ‘at least one of A, B and C’ and ‘at least one of A, B or C’ may respectively include any one of items listed together in a corresponding phrase among those phrases or any possible combination thereof.

Hereinafter, the present disclosure will be described in further detail with reference to the accompanying drawings.

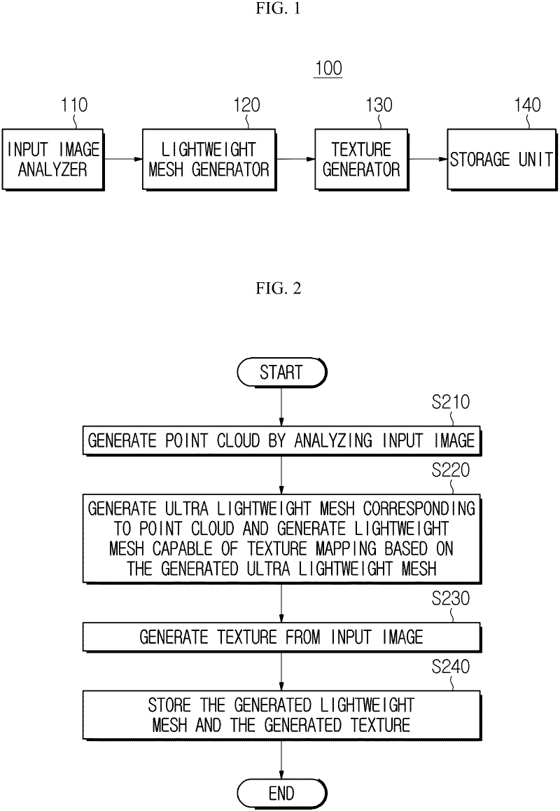

FIG. 1 is a view illustrating a configuration of an image-based lightweight three-dimensional model replication device according to an embodiment of the present disclosure.

Referring to FIG. 1, an image-based lightweight three-dimensional model replication device 100 includes an input image analyzer 110, a lightweight mesh generator 130, a texture generator 130, and a storage unit 140.

The input image analyzer 110 generates a high-density point cloud corresponding to a building surface by analyzing three-dimensional spatial information of a plurality of input urban images (photos).

The input image analyzer 110 generates a point cloud by analyzing an input image.

The lightweight mesh generator 120 generates an ultra lightweight mesh based on a point cloud and generates a lightweight mesh capable of mapping a texture based on the generated ultra lightweight mesh.

The lightweight mesh generator 120 groups a point cloud, generates an ultra lightweight mesh based on the grouped point cloud, generates a lightweight mesh by performing a remeshing operation based on the generated ultra lightweight mesh, and generates a texture coordinate corresponding to the texture based on the generated lightweight mesh.

The lightweight mesh generator 120 groups the point cloud in any face unit of a wall face or a roof face of the input image.

The lightweight mesh generator 120 groups the point cloud in different colors for each individual building included in the input image.

The lightweight mesh generator 120 generates an ultra lightweight mesh based on the grouped point cloud, places an initial plane on the grouped point cloud, places a final plane by tuning at least one of the slope and position of the placed initial plane, and generates an ultra lightweight mesh by cutting based on a relation between the placed final plane and a neighboring plane.

The lightweight mesh generator 120 generates a lightweight mesh by performing a remeshing operation based on the generated ultra lightweight mesh and generates a lightweight mesh by performing a remeshing operation that makes an ultra lightweight mesh uniform in a predetermined size. An ultra lightweight mesh consists of triangles, and a lightweight mesh consists of rectangles with a uniform size.

Herein, the number of lightweight meshes is different from that of ultra lightweight meshes. The number of the lightweight meshes is larger than that of the ultra lightweight meshes.

The lightweight mesh generator 120 generates a texture coordinate corresponding to the texture based on the lightweight mesh, groups the lightweight mesh based on position, generates a texture patch based on the grouped lightweight mesh, and generates a texture coordinate based on the generated texture patch.

The lightweight mesh generator 120 generates a texture coordinate by using a technique of automatically generating a UV layout based on the generated texture patch.

Herein, the input image includes a two-dimensional image.

The texture generator 130 generates a texture from the input image.

The texture generator 130 generates a texture on a lightweight mesh model.

The texture generator 130 generates a texture from an input image by considering the position and direction of a polygon constituting a lightweight mesh.

The storage unit 140 stores the generated lightweight mesh and the generated texture.

The storage unit 140 stores the generated mesh and texture in a file format desired by a user. Herein, the storage unit 140 includes a memory.

Herein, the file format may be a format that is applicable irrespective of a type of a device.

FIG. 2 is a flowchart showing a method for replicating a lightweight three-dimensional model based on an image according to an embodiment of the present disclosure. The present invention is implemented by the image-based lightweight three-dimensional model replication device 100.

Referring to FIG. 2, a point cloud is generated by analyzing an input image (S210).

An ultra lightweight mesh corresponding to the point cloud is generated, and a lightweight mesh capable of mapping a texture is generated based on the generated ultra lightweight mesh (S220).

A texture is generated from the input image (S230).

The generated mesh and the generated texture are stored (S240).

Specifically, the generated mesh and the generated texture are stored in the memory 140.

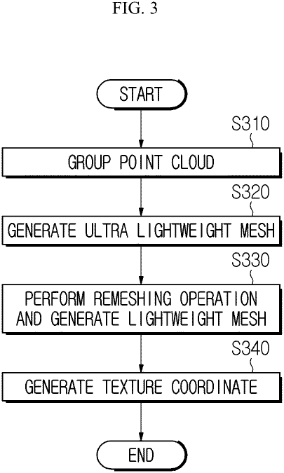

FIG. 3 is a view illustrating a process of generating a lightweight mesh model capable of texture mapping according to an embodiment of the present disclosure. The present invention is implemented by the lightweight mesh generator 120.

First, a point cloud is grouped (S310).

An ultra lightweight mesh is generated based on the grouped point cloud (S320).

Based on the generated ultra lightweight mesh, a remeshing operation is performed to generate a lightweight mesh (S330).

Based on the lightweight mesh, a texture coordinate corresponding to the texture is generated (S340).

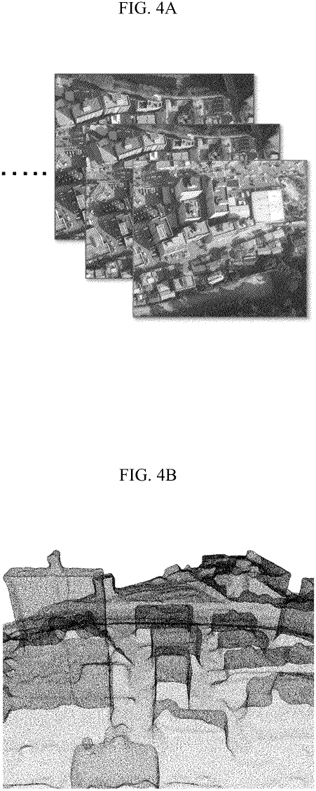

FIG. 4A and FIG. 4B are views illustrating an input image and a point cloud according to an embodiment of the present disclosure.

FIG. 4A is a view illustrating an input image. FIG. 4B is a view illustrating a point cloud.

Referring to FIG. 4A, an input image includes at least one aerial photograph and a 2D image. In addition, the input image includes at least one multiview aerial photograph and a multiview 2D image.

Referring to FIG. 4B, a point cloud means a set of points spreading in a three-dimensional space.

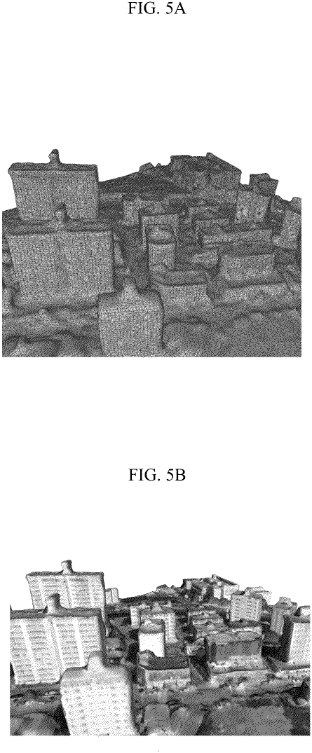

FIG. 5A and FIG. 5B are views each illustrating an output of the related art.

FIG. 5A is a view illustrating a high-density mesh model. FIG. 5B is a view illustrating addition of a texture to a high-density mesh model.

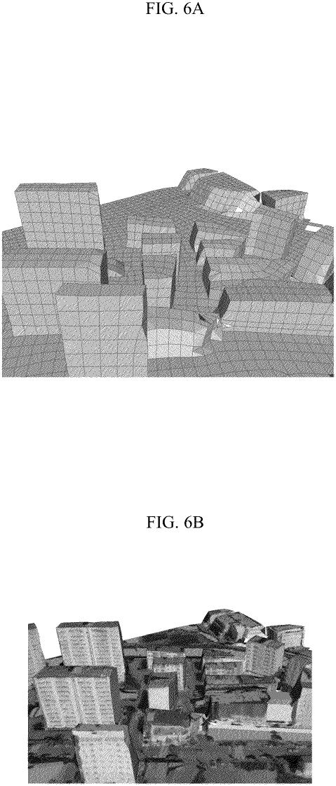

FIG. 6A and FIG. 6B are views each illustrating an output of the present invention according to an embodiment of the present disclosure.

FIG. 6A is a view illustrating a lightweight model. FIG. 6B is a view illustrating addition of a texture to a lightweight model.

When FIG. 5B and FIG. 6B are compared, the high-density reconstruction model illustrated in FIG. 5B is better than the lightweight reconstruction model in terms of specific details.

However, compared with what is described and represented by the high-density reconstruction model, the lightweight reconstruction model has an advantage of reducing a file size while not lowering accuracy significantly.

In the related art, after a high-density reconstruction model is generated, a converting operation is manually performed as the latter half to generate a lightweight model.

According to the present invention, user convenience may be enhanced as a three-dimensional lightweight model with a reduced file size based on a multiview two-dimensional image may be automatically generated without manual operation.

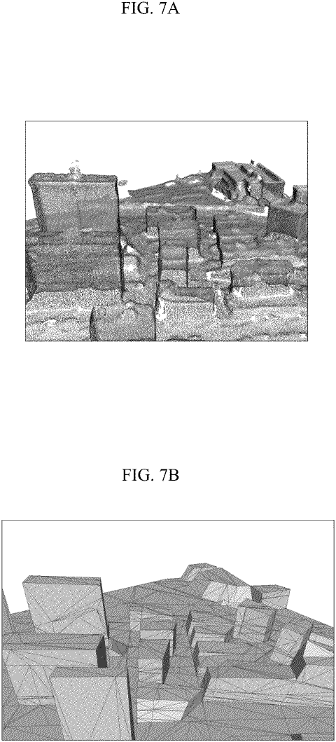

FIG. 7A and FIG. 7B are views illustrating a step of grouping a point cloud and a step of generating an ultra lightweight mesh according to an embodiment of the present disclosure.

FIG. 7A is a view illustrating a grouped point cloud.

FIG. 7B is a view illustrating an ultra lightweight mesh model.

Referring to FIG. 7A, grouping of a point cloud will be described. A point cloud is grouped in any face unit of a wall face or a roof face of an input image.

For example, through a geometric analysis, a cluster is found and classified in a face unit of a wall face or a roof face. A segmentation method like RANSAC may be used to group a point cloud. RANSAC means a method of analyzing the entire data by taking samples repeatedly from given data. As RANSAC does not use all data, it is relatively faster and resistant to noise.

When a point cloud is grouped, the point cloud is grouped in different colors for each individual building included in an input image.

Generating an ultra lightweight mesh will be described with reference to FIG. 7B.

Specifically, an initial plane is placed on the grouped point cloud, a final plane is placed by tuning at least one of the slope and position of the placed initial plane, and an ultra lightweight mesh is generated by cutting based on a relation between the placed final plane and a neighboring plane.

For example, initial planes are placed on groups, a final plane is placed by tuning the slopes or positions of the planes, and an ultra lightweight mesh model is generated by cutting in consideration of a relation between the planes and a neighboring plane. An ultra lightweight model may be generated by utilizing the polygonal surface reconstruction technology.

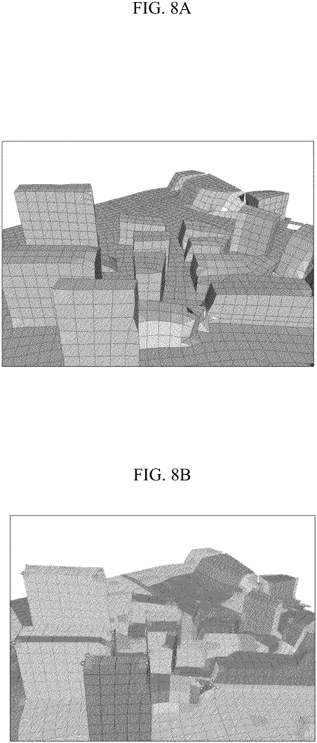

FIG. 8A and FIG. 8B are views illustrating a step of generating a lightweight mesh and a step of generating a texture coordinate according to an embodiment of the present disclosure.

FIG. 8A is a view illustrating a lightweight mesh that is generated.

FIG. 8B is a view illustrating addition of a texture coordinate to a lightweight mesh model.

Referring to FIG. 8A, generation of a lightweight mesh will be described.

A lightweight mesh is generated by performing a remeshing operation that makes an ultra lightweight mesh uniform in a predetermined size.

Specifically, as an ultra lightweight mesh includes an irregular shape, it is not suitable for texture mapping. Accordingly, it is necessary to perform a remeshing operation for reconstructing an ultra lightweight mesh into a mesh with a predetermined size.

An ultra lightweight mesh consists of triangles, and a lightweight mesh consists of rectangles with a uniform size.

When a remeshing operation is performed, the number of lightweight meshes is different from that of ultra lightweight meshes. Specifically, the number of the lightweight meshes is larger than that of the ultra lightweight meshes.

A light mesh is generated with a small increase in the number of meshes. In this case, a remeshing technique like the quad-based autoretopology may be used.

Referring to FIG. 8B, generation of a texture coordinate will be described.

A lightweight mesh is grouped based on a position, and a texture patch is generated based on the grouped lightweight mesh. Based on the generated texture patch, a texture coordinate is generated.

For example, in order to generate an effective texture, a mesh is grouped based on a position, and a texture patch is constructed.

As illustrated in FIG. 8B, a texture patch is generated in a unit of wall face of a building. Herein, when the texture patch is constructed, a technique of automatically generating a UV layout may be used.

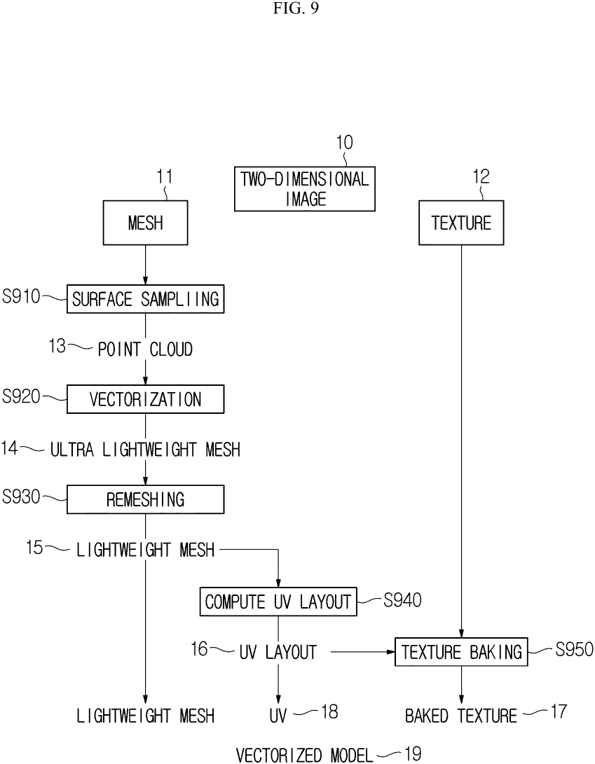

FIG. 9 is a view illustrating a process of generating a lightweight mesh according to an embodiment of the present disclosure.

As illustrated in FIG. 9, a mesh 12 and a texture 14 are extracted from a two-dimensional image 10.

Surface sampling of the mesh 12 is performed (S910).

In the surface sampling, a mesh 11 is received as an input, and a point cloud 13 is output.

Hereinafter the surface sampling will be described.

As the vectorizing technology has the point cloud 13 as an input, the point cloud 13 is extracted from the mesh model 11.

A method of obtaining a point cloud from the mesh 11 is to covert a vertex to a point cloud. However, since a vertex generally has a low density, the density needs to be increased in order to apply a vectorization algorithm. The point cloud 13 with a density as high as necessary is generated by sampling a point of a mesh based on a position of a vertex.

Vectorization of a point cloud is performed (S920).

In the vectorization, an ultra lightweight mesh 14 is output from the input of the point cloud 13.

The vectorization is performed using the kinetic shape reconstruction. First, a point cloud is divided using a RANSAC algorithm based on initial compression, and an initial surface is generated in the beginning of a vectorizing process. As a result, the ultra lightweight mesh 14 is generated.

Remeshing is performed (S930).

In the remeshing, a lightweight mesh 15 is output by receiving the ultra lightweight mesh 14 as input.

In the previous step of vectorization (S920), an output is the ultra lightweight mesh 14 consisting of polygons with irregular sizes. In the remeshing step, the ultra lightweight mesh 14 is converted into the lightweight mesh 15 by implementing a remeshing process.

Herein, an instant mesh is a technology optimized to accomplish such an objective. When the number of target polygons is input by supporting obj format, a lightweight mesh version with a general mesh size is automatically generated. Thus, a UV layout may be easily made, and LOD may be applied.

An output of the remeshing step (S930) is the ultra lightweight mesh 15.

The UV layout is computed (S940).

In the case of the UV layout, the ultra lightweight mesh 15 is received as an input, and a UV layout 16 is output.

A UV layout means a visual representation of a three-dimensional model which is flattened on a two-dimensional plane. Each point of a two-dimensional plane is a UV, representing a vertex of a three-dimensional object. In this way, every area within a UV layout boundary corresponds to a specific point of a model.

A new UV layout for texture mapping of a target mesh is generated. It takes a longest time to generate a UV coordinate, and a UV map is unfolded with care.

In order to automate this step, a technique of generating a UV layout is based on a geometric structural analysis of a model. When an urban space model is a target, if the wall of a building is set as a mapping unit (atlas), a good UV mapping output may be obtained.

In the present invention, a generalized motorcycle graph is used. This technique has excellent performance of generating a UV coordinate in a mesh model, which is constructed in cubic units, especially in a building model.

Texture baking is performed (S950).

In the case of texture baking, the UV layout 16 and the texture 12 are received as inputs, and a baked texture 17 is output.

Texture baking means a process of baking external color information of an original model onto a texture of a target model.

A texture-mapped original, a texture coordinate and a vectorized mesh are loaded in a blender, and the following process is performed using a baking function of a cycle renderer installed in the blender. Specifically, an original diffuse color is copied into a texture of a target model.

A vectorized model 19, which is an output of the process illustrated in FIG. 9, includes the lightweight mesh 15, the UV 18, and the baked texture 17.

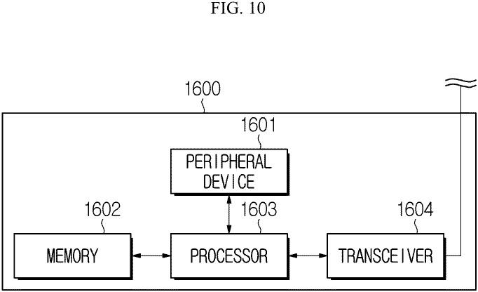

FIG. 10 is a view illustrating a configuration of an image-based lightweight three-dimensional model replication device according to an embodiment of the present disclosure.

An embodiment of the image-based lightweight three-dimensional model replication device 100 of FIG. 10 may be a device 1600. Referring to FIG. 10, the device 1600 may include a memory 1602, a processor 1603, a transceiver 1604 and a peripheral device 1601. In addition, for example, the device 1600 may further include another configuration and is not limited to the above-described embodiment.

More specifically, the device 1600 of FIG. 10 may be an exemplary hardware/software architecture such as a three-dimensional model replication device and an image processing device. Herein, as an example, the memory 1602 may be a non-removable memory or a removable memory. In addition, as an example, the peripheral device 1601 may include a display, GPS or other peripherals and is not limited to the above-described embodiment.

In addition, as an example, like the transceiver 1604, the above-described device 1600 may include a communication circuit. Based on this, the device 1600 may perform communication with an external device.

In addition, as an example, the processor 1603 may be at least one of a general-purpose processor, a digital signal processor (DSP), a DSP core, a controller, a micro controller, application specific integrated circuits (ASICs), field programmable gate array (FPGA) circuits, any other type of integrated circuit (IC), and one or more microprocessors related to a state machine. In other words, it may be a hardware/software configuration playing a controlling role for controlling the above-described device 1600.

Herein, the processor 1603 may execute computer-executable commands stored in the memory 1602 in order to implement various necessary functions of the image-based lightweight three-dimensional model replication device. As an example, the processor 1603 may control at least any one operation among signal coding, data processing, power controlling, input and output processing, and communication operation. In addition, the processor 1603 may control a physical layer, an MAC layer and an application layer. In addition, as an example, the processor 1603 may execute an authentication and security procedure in an access layer and/or an application layer but is not limited to the above-described embodiment.

In addition, as an example, the processor 1603 may perform communication with other devices via the transceiver 1604. As an example, the processor 1603 may execute computer-executable commands so that a three-dimensional model replication device may be controlled to perform communication with other devices via a network. That is, communication performed in the present invention may be controlled. As an example, the transceiver 1604 may send a RF signal through an antenna and may send a signal based on various communication networks.

In addition, as an example, MIMO technology and beam forming technology may be applied as antenna technology but are not limited to the above-described embodiment. In addition, a signal transmitted and received through the transceiver 1604 may be controlled by the processor 1603 by being modulated and demodulated, which is not limited to the above-described embodiment.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for generating a lightweight three-dimensional model based on an image, the method comprising:
generating a point cloud by analyzing an input image;
generating an ultra lightweight mesh based on the point cloud and generating a lightweight mesh capable of texture mapping based on the generated ultra lightweight mesh;
generating a texture from the input image; and
storing the generated lightweight mesh and the texture.

2. The method of claim 1, further comprising:
grouping the point cloud;
generating the ultra lightweight mesh based on the grouped point cloud;
generating the lightweight mesh by performing a remeshing operation based on the generated ultra lightweight mesh; and
generating, based on the lightweight mesh, a texture coordinate corresponding to the texture.

3. The method of claim 2, wherein the grouping of the point cloud comprises grouping the point cloud in any one face unit of a wall face or a roof face of the input image.

4. The method of claim 2, wherein the grouping of the point cloud comprises grouping the point cloud in a different color in each building included in the input image.

5. The method of claim 2, wherein the generating of the ultra lightweight mesh based on the grouped point cloud further comprises:
placing an initial plane on the grouped point cloud;
placing a final plane by tuning at least one of a slope and a position of the placed initial plane; and
generating the ultra lightweight mesh by cutting based on a relation between the placed final plane and a neighboring plane.

6. The method of claim 2, wherein the generating of the lightweight mesh by performing the remeshing operation based on the generated ultra lightweight mesh further comprises generating the lightweight mesh by performing the remeshing operation that makes the ultra lightweight mesh uniform in a predetermined size.

7. The method of claim 2, wherein a number of the lightweight mesh is different from a number of the ultra lightweight mesh.

8. The method of claim 2, wherein the generating of the texture coordinate corresponding to the texture based on the lightweight mesh further comprises:
grouping the lightweight mesh based on a position;
generating a texture patch based on the grouped lightweight mesh; and
generating the texture coordinate based on the generated texture patch.

9. The method of claim 8, wherein the texture coordinate is generated by using a UV layout automatic generation technique based on the generated texture patch.

10. The method of claim 1, wherein the input image includes a two-dimensional image.

11. An apparatus for generating a lightweight three-dimensional model based on an image, the apparatus comprising:
an input image analyzer configured to generate a point cloud by analyzing an input image;
a lightweight mesh generator configured to generate an ultra lightweight mesh based on the point cloud and to generate a lightweight mesh capable of texture mapping based on the generated ultra lightweight mesh;
a texture generator configured to generate a texture from the input image; and
a storage unit configured to store the generated lightweight mesh and the generated texture.

12. The apparatus of claim 11, wherein the lightweight mesh generator is further configured to:
group the point cloud,
generate the ultra lightweight mesh based on the grouped point cloud,
generate the lightweight mesh by performing a remeshing operation based on the generated ultra lightweight mesh, and
generate, based on the lightweight mesh, a texture coordinate corresponding to the texture.

13. The apparatus of claim 12, wherein the lightweight mesh generator is further configured to group the point cloud in any one face unit of a wall face or a roof face of the input image.

14. The apparatus of claim 12, wherein the lightweight mesh generator is further configured to group the point cloud in a different color in each building included in the input image.

15. The apparatus of claim 12, wherein the lightweight mesh generator is further configured to:
place an initial plane on the grouped point cloud,
place a final plane by tuning at least one of a slope and a position of the placed initial plane, and
generate the ultra lightweight mesh by cutting based on a relation between the placed final plane and a neighboring plane.

16. The apparatus of claim 12, wherein the lightweight mesh generator is further configured to:
generate the lightweight mesh by performing the remeshing operation that makes the ultra lightweight mesh uniform in a predetermined size.

17. The apparatus of claim 12, wherein a number of the lightweight mesh is different from a number of the ultra lightweight mesh.

18. The apparatus of claim 12, wherein the lightweight mesh generator is further configured to:
group the lightweight mesh based on a position,
generate a texture patch based on the grouped lightweight mesh, and
generate the texture coordinate based on the generated texture patch.

19. The apparatus of claim 18, wherein the lightweight mesh generator is further configured to generate the texture coordinate by using a UV layout automatic generation technique based on the generated texture patch.

20. An apparatus for generating a lightweight three-dimensional model based on an image, the apparatus comprising:
a transceiver configured to transmit and receive data to and from an external apparatus;
a processor configured to:
generate a point cloud by analyzing an input image corresponding to the data,
generate an ultra lightweight mesh based on the point cloud, generate a lightweight mesh capable of texture mapping based on the generated ultra lightweight mesh, and
generate a texture from the input image; and
a memory configured to store the generated lightweight mesh and the generated texture.
